(19) United States
(12) Patent Application Publication
(10) Pub. No.: US 2018/0057705 A1
(43) Pub. Date: Mar. 1, 2018

(54) COATING METHOD

(71) Applicant: Samsung Display Co., Ltd., Yongin-si (KR)

(72) Inventors: Jae Hoon JUNG, Bucheon-si (KR); Han Gyeol KIM, Hwaseong-si (KR); Dae Ho YOON, Hanam-si (KR)

(21) Appl. No.: 15/663,388

(22) Filed: Jul. 28, 2017

(30) Foreign Application Priority Data
Aug. 23, 2016 (KR) 10-2016-0106940

(51) Int. Cl. C09D 175/04; C09D 133/06; C09D 5/00; C08G 18/62; C08G 18/63; B05D 7/00; B05D 1/00

(52) U.S. Cl. CPC C09D 175/04; C09D 133/062; C09D 5/002; C08G 18/6233; B05D 1/007; C08G 18/631; B05D 7/572; B05D 7/577; C08G 18/6254

(57) ABSTRACT

A coating method includes coating a first coating composition including a heterogeneous photoinitiator having a first photoinitiator and a second photoinitiator on a substrate, irradiating ultraviolet rays having a first wavelength into the first coating composition to form a first coating layer and cure the first photoinitiator, coating a second coating composition on the first coating layer, and irradiating ultraviolet rays having a second wavelength different than the first wavelength into the second coating composition to form a second coating layer.

### CROSS-REFERENCE TO RELATED APPLICATION

This application claims priority from and the benefit of Korean Patent Application No. 10-2016-0106940 filed on Aug. 23, 2016, which is hereby incorporated by reference for all purposes as if fully set forth herein.

### BACKGROUND

### Field

The invention relates generally to a coating method, and, more particularly, to coating multiple layers having differing particulate compositions on a substrate to improve adhesion between the layers.

### Discussion of the Background

In general, transparent plastic (e.g., PMMA, PET, PC) is light and easy to mold by heat, and has excellent durability and chemical resistance such that the transparent plastic is suitable for a wide range of applications from electrical components to general household goods. The most commonly used transparent plastic material is polycarbonate, and polycarbonate has light transmittance of about 90% and excellent impact resistance such that it is suitable for replacing glass, thereby being widely used in fields such as those of automobiles, architecture, ornaments, and optical lenses.

However, polycarbonate, which is a plastic resin, has a mostly soft surface, unlike glass, such that there are drawbacks. For example, the plastic resin is easily scratched and has a weak chemical resistance. To solve these drawbacks, a method of hard coating plastic surfaces is commonly used, and this method forms a hard film having a high hardness on the plastic surface, thereby preventing the appearance from being damaged by the generation of scratches on the surface while simultaneously improving chemical resistance. To increase the hardness of the plastic, the hard surface coating must have a sufficient thickness.

The above information disclosed in this Background section is only for enhancement of understanding of the background of the inventive concepts, and, therefore, it may contain information that does not form the prior art that is already known in this country to a person of ordinary skill in the art.

### SUMMARY

The inventors have discovered that, when providing a hard surface coating having a sufficient thickness to prevent damage to a plastic substrate, it can be difficult to properly cure the coating when the coating is made from a single coating layer. However, the inventors have also discovered that, when providing a hard surface coating having multiple layers, it can be difficult to properly adhere the coating layers to each other and they may peel off during use.

Coating methods according to the principles of the invention are capable of forming a coating layer having a multi-layered coating structure with improved adhesion between the layers. Coating methods of the invention can produce structures with coating layers having a high hardness while minimizing peeling off of layers.

Additional aspects will be set forth in the detailed description which follows, and, in part, will be apparent from the disclosure, or may be learned by practice of the inventive concepts.

A coating method according to the principles of the invention includes coating a first coating composition including a heterogeneous photoinitiator having a first photoinitiator and a second photoinitiator on a substrate, irradiating ultraviolet rays having a first wavelength into the first coating composition to form a first coating layer and cure the first photoinitiator, coating a second coating composition on the first coating layer, and irradiating ultraviolet rays having a second wavelength different than the first wavelength into the second coating composition to form a second coating layer.

The first wavelength may have a range of about 280 nm to about 315 nm.

The second wavelength may have a range of about 200 nm to about 279 nm.

In the step of forming the first coating layer, the second photoinitiator does not react.

After the step of forming the first coating layer, protrusions and depressions may be formed at a surface of the first coating layer.

After the step of forming the first coating layer, a surface of the first coating layer may have a viscosity.

The step of forming the second coating layer may include curing the second photoinitiator included in the first coating layer.

The second coating composition may include the second photoinitiator.

The first photoinitiator may include methyl-4′-(methylthio)-2-morpholinopropiophenone.

The second photoinitiator may be one or more material selected from the group consisting of hydrocyclohexyl phenyl ketone, 2-hydroxy-2-methylpropiophenone, benzoin ethyl ether, benzoin methyl ether, and benzoin isobutyl ether.

The first coating composition may include an oligomer, a monomer, and an inorganic nanoparticle.

The total weight of the oligomer, the monomer, the photoinitiator, and the inorganic nanoparticle included in the first coating composition may be less than about 70 wt % of the first coating composition.

The substrate may include one or more material selected from a group including polycarbonate, poly(methylmethacrylate), and polyethylene phthalate.

The step of forming the first coating layer may include forming a height of the first coating layer in the range of about 5 μm to about 15 μm, and the step of forming the second coating layer may include forming a height of the second coating layer in the range of about 5 μm to about 15 μm.

Another exemplary coating method according to the principles of the invention includes coating a first coating composition including a hydrophilic leveling agent onto a substrate, irradiating ultraviolet rays into the first coating composition to form a first coating layer, coating a second coating composition onto the first coating layer, and irradiating ultraviolet rays into the second coating composition to form a second coating layer.

The hydrophilic leveling agent may be one or more compounds selected from a compound represented by Chemical Formula 1 and a compound represented by Chemical Formula 2, and the hydrophilic leveling agent is included in the first coating composition at less than about 1 wt %.

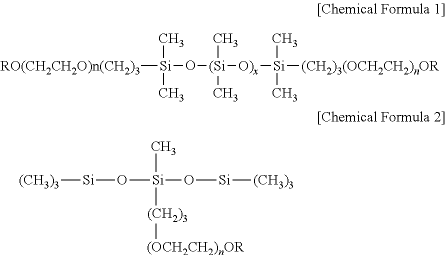

Herein, n and x are independently 1 to 20, and R is hydrogen.

After the step of forming the first coating layer, protrusions and depressions may be formed at a surface of the first coating layer.

After the step of forming the first coating layer, a surface of the first coating layer may have a viscosity.

The step of forming the first coating layer may include forming a height of the to first coating layer in the range of about 5 μm to about 15 μm, and the step of forming the second coating layer may include forming a height of the second coating layer in the range of about 5 μm to about 15 μm.

The heterogeneous photoinitiator may include a first photoinitiator cured in the first wavelength range and a second photoinitiator cured in the second wavelength range, the second coating composition may include the second photoinitiator cured in the second wavelength range, the first wavelength may be in the range of about 280 nm to about 315 nm, and the second wavelength may be in the range of about 200 nm to about 279 nm.

According to the principles of the invention, the methods of forming the coating layer provide interlayer adhesion between the layers of the multi-layered structure.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1A is a schematic cross-sectional view of a first stage in a first embodiment of a method of coating according to the principles of the invention.

FIG. 1B is a schematic cross-sectional view of a second stage in the first embodiment of the method of coating according to the principles of the invention.

FIG. 1C is a schematic cross-sectional view of a third stage in the first embodiment of the method of coating according to the principles of the invention.

FIG. 1D is a schematic cross-sectional view of a fourth stage in the first embodiment of the method of coating according to the principles of the invention.

FIG. 2A is a schematic cross-sectional view of a first stage in a second embodiment of a method of coating according to the principles of the invention.

FIG. 2B is a schematic cross-sectional view of a second stage in the second embodiment of the method of coating according to the principles of the invention.

FIG. 2C is a schematic cross-sectional view of a third stage in the second embodiment of the method of coating according to the principles of the invention.

FIG. 2D is a schematic cross-sectional view of a fourth stage in the second embodiment of the method of coating according to the principles of the invention.

FIG. 3A is a photographic plan view illustrating the results of an adhesion test for a coating layer manufactured according to the principles of the invention.

FIG. 3B is a photographic plan view illustrating the results of an adhesion test for a coating layer manufactured according to a comparative example.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

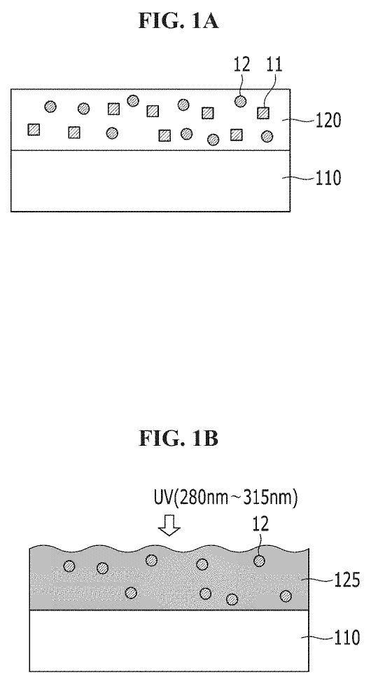

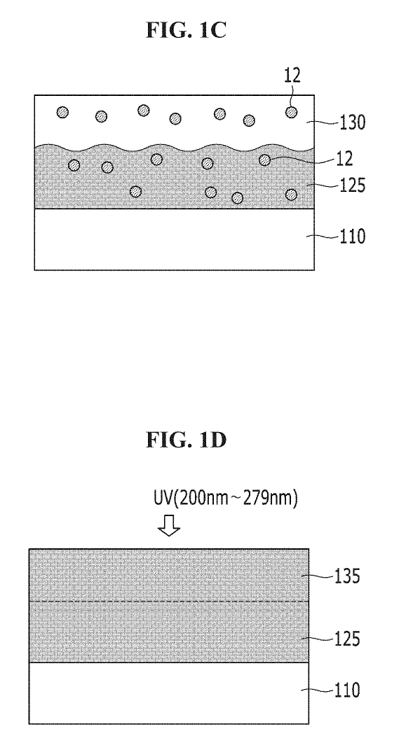

A coating method according to the principles of the invention will be described in detail with reference to accompanying drawings. Referring to FIG. 1A, the first coating composition 120 including a heterogeneous photoinitiator is first coated on the substrate 110. As discussed below, a photoinitiator is a material that guides photocuring during light irradiation, and a heterogeneous photoinitiator is a photoinitator that is made up of particles having different sizes, shapes or other physical characteristics. The substrate 110 may include a plastic. In detail, the substrate 110 may include at least one material selected from a group including polycarbonate, poly(methylmethacrylate), and polyethylene phthalate.

The first coating composition 120 may include a hard coating material and a heterogeneous photoinitiator. Also, to increase hardness of the coating layer, the first coating composition 120 may further include an inorganic nanoparticle. The first coating composition 120 may include a solvent, an oligomer, a monomer, a photoinitiator, and an inorganic nanoparticle. The total weight of the oligomer, the monomer, the photoinitiator, and the inorganic nanoparticle for the coating composition 120 may be less than 70 wt %. The weight of the inorganic nanoparticle may be less than 5 wt %.

A solvent of the first coating composition 120 may include a ketone or an alcohol. For example, the solvent may include at least one material selected from the group including IPA, MEK, methyl alcohol, PGMEA, 2-propanol, propylene glycol monomethyl ether (PGME), ethyl methyl ketone, and diisobutyl ketone.

Also, the coating composition 120 may include at least one oligomer selected from the group including an acrylate oligomer, a methacrylate oligomer, a urethane acrylate oligomer, and a hyperbranched methacrylate monomer. For example, dipentaerythritol hexaacrylate may be included in the coating composition 120.

The first coating composition 120 may further include one or more monomers having at least one functional group. The monomer having at least one functional group may include at least one selected from a group including hexamethylene diisocyanate (HDI), pentaerythritol triacrylate (PETA), hexanediol diacrylate (HDDA), propoxylated glycerol triacrylate (GPTA), ethoxylated trimethylol propane triacrylate (EOTMPTA), trimethylol propane triacrylate (TMPTA), and tripropylene glycol diacrylate (TPGDA).

The inorganic nanoparticle included in the first coating composition 120 may be one or more materials selected from the group including silica (SiO₂), alumina (Al₂O₃), zirconia (ZrO₂), and titania (TiO₂). The size of the inorganic nanoparticle may be about 10 nm to 50 nm.

Also, the inorganic nanoparticle may include a reaction group. That is, the inorganic nanoparticle may be chemically combined with an oligomer, a polyfunctional monomer, or a monofunctional monomer and may be included in the first coating composition 120 in that manner.

However, the composition of the first coating composition 120 is not limited to the foregoing, and other materials for improving strength of the substrate 110 by coating a material on the substrate 110 may be used as is known in the art.

The first coating composition 120 may include a first photoinitiator 11 and a second photoinitiator 12. A photoinitiator is a material that guides photocuring during light irradiation, and the coating composition is cured when the light is irradiated to the coating composition including the photoinitiator.

The first photoinitiator 11 and the second photoinitiator 12 have different wavelengths generating the photocuring process. The first photoinitiator 11 may generate the curing when irradiating light in a wavelength range of about 280 nm to about 315 nm. In this example, the wavelength range of about 280 nm to about 315 nm for generating the curing of the first photoinitiator 11 is referred to as a first wavelength. The second photoinitiator 12 may generate the curing when irradiating light in a wavelength range of about 200 nm to about 279 nm. In this example, the wavelength range of about 200 nm to about 279 nm for generating the curing of the second photoinitiator 12 is referred to as a second wavelength.

The first photoinitiator 11 may include methyl-4′-(methylthio)-2-morpholinopropiophenone.

The second photoinitiator 12 may include at least one material selected from the group including hydrocyclohexyl phenyl ketone, 2-hydroxy-2-methylpropiophenone, benzoin ethyl ether, benzoin methyl ether, and benzoin isobutyl ether.

The total weight of the first photoinitiator 11 and the second photoinitiator 12 included in the first coating composition 120 may be in a range of about 0.1 wt % to about 5 wt %.

The thickness of the first coating composition 120 after being coated may be in a range of about 5 μm to about 15 μm.

Referring to FIG. 1B, ultraviolet rays having the first wavelength are irradiated to cure the first composition, thereby forming the first coating layer 125. The first wavelength is a wavelength in a range of about 280 nm to about 315 nm.

The first photoinitiator 11 included in the first coating composition 120 reacts to the light such that polymers in the first coating composition 120 are polymerized, thereby forming the first coating layer 125.

However, the second photoinitiator 12 included in the first coating composition 120 is not cured by the first wavelength. Accordingly, the second photoinitiator 12 in the first coating layer 125 remains in an unreacted state as depicted in FIG. 1B. Because the unreacted second photoinitiator 12 remains unreacted therein, the first coating layer 125 is also not cured as a whole. Accordingly, as shown in FIG. 1B, the surface of the first coating layer 125 is not flat as protrusions and depressions are formed therein to create a way, irregular surface. The protrusions and depressions are formed since the unreacted second photoinitiator 12 remains in a sticky state having a viscosity such that the protrusions and depressions may be formed throughout the entire surface, or at least on some of the surface, of the first coating layer 125. That is, due to the unreacted second photoinitiator 12 positioned near the surface of the first coating layer 125, the surface of the first coating layer 125 has a viscosity arising from the presence of the unreacted second photoinitiator 12.

The protrusions and depressions and the viscosity of the surface of the first coating layer 125 improves the adhesion of the first coating layer 125 and the second coating layer 135 in the subsequent process of forming the second coating layer 135. Additional details regarding this improved adhesion will be described in detail subsequently.

Next, referring to FIG. 1C, the second coating composition 130 is coated on the first coating layer 125. The second coating composition 130 may be coated with a thickness of about 5 μm to about 15 μm.

The protrusions and depressions formed on the surface of the first coating layer 125 closely contact the second coating composition 130 and the first coating layer 125 due to an anchor effect. The anchor effect is an effect in which a coating solution is fixed to the surface protrusions and depressions and is well-coated when the coating solution inflows to conform to the contours of a surface having roughness. Also, since the surface of the first coating layer 125 is in the sticky state while having the viscosity due the unreacted second photoinitiator 12, the second coating composition 130 may be evenly adhered to the first coating layer 125.

The second coating composition 130 may include material of substantially the same composition as the first coating composition 120 except that it includes a single type of photoinitiator, i.e., it is homogenous. That is, the second coating composition 130 includes the solvent, the oligomer, the monomer, the photoinitiator, and the inorganic nanoparticle, and the total weight of the oligomer, the monomer, the photoinitiator, and the inorganic nanoparticle for the second coating composition 130 may be less than about 70 wt %. The weight of the inorganic nanoparticle may be less than 5 wt %, and the weight of the photoinitiator may be in the range of about 0.1 wt % to about 5 wt %. The description of the solvent, the oligomer, the monomer, and the inorganic nanoparticle is the same as described above. Thus, a duplicative detailed description for the same constituent elements is omitted below to avoid redundancy.

As noted above, the second coating composition 130 only includes the photoinitiator that is cured in the second wavelength range. That is, the second coating composition 130 may include the second photoinitiator 12. The second photoinitiator 12 may be cured when irradiating the light of a wavelength range of about 200 nm to about 279 nm. The second photoinitiator 12 may one or more materials selected from the group including hydrocyclohexyl phenyl ketone, 2-hydroxy-2-methylpropiophenone, benzoin ethyl ether, benzoin methyl ether, and benzoin isobutyl ether. However, the second photoinitiator 12 included in the first coating composition 120 and the second photoinitiator 12 included in the second coating composition 130 may be the same as or different from each other. But, even if the material composition of the second photoinitiator in the first coating composition 120 and the second coating composition 130 are different from each other, the second photoinitiator 12 included in the first coating composition 120 and the second photoinitiator 12 included in the second coating composition 130 are nevertheless both cured in the second wavelength range of about 200 nm to about 279 nm.

Also, the type and the constituents of the oligomer, the monomer, and the inorganic nanoparticle included in the first coating composition 120 and the second coating composition 130 may be different from each other. That is, the compositions of the first coating composition 120 and the second coating composition 130 are not always the same.

Next, referring to FIG. 1D, the light of the second wavelength (about 200 nm to about 279 nm) is irradiated to form the second coating layer 135. As shown in FIG. 1D, the second photoinitiator 12 included in the second coating composition 130 and the second photoinitiator 12 included in the first coating layer 125 react to the irradiation of the light of the second wavelength such that a photopolymerization reaction is generated.

When the second photoinitiator 12 included in the second coating composition 130 is reacted, the second coating composition 130 is cured into the second coating layer 135. Also, in that step of the process, the second photoinitiator 12 included in the first coating layer 125 is photo-polymerized at the interface of the first coating layer 125 and the second coating layer 135 such that the adhesion of the first coating layer 125 and the second coating layer 135 is enhanced. That is, while the photopolymerization is generated at the interface of the first coating layer 125 and the second coating layer 135, the protrusions and depressions of the surface of the first coating layer 125 are removed and the first coating layer 125 and the second coating composition 135 are strongly adhered to each other.

The method of manufacturing the coating layer described above sequentially coats and respectively cures the first coating layer 125 and the second coating layer 135 to form a complete coating layer. Accordingly, the complete coating layer has a thickness greater than either the first coating layer 125 or the second coating layer 135 have individually. That is, the coating layer formed on the plastic substrate or the film may have sufficient hardness to overcome the problems associated with the lower hardness of the plastic as described above. To provide the higher hardness of the coating layer, the increased thickness of the coating layer resulting from the presence of both the first coating layer 125 and the second coating layer 135 is beneficial. Conversely, when the coating layer is formed of a single layer, it is difficult to form a coating layer sufficiently thick to achieve the desired benefits. This is because it is not only difficult to uniformly coat a thick coating composition of a single layer, but it is also difficult to uniformly cure a thickly coated coating composition in a single process step.

According to coating methods prior to the inventive concepts herein, a coating layer may be formed in a plurality of layers in order to form a thick coating layer having a high hardness. That is, the method of coating and curing the first coating composition to form the first coating layer and then coating and curing the second coating composition to form the second coating layer is provided. However, when the coating layer is formed of the multi-layered structure, the adhesion is weak at the interface of the multi-layered coating layer, and accordingly there has been a problem with the coating layer made by conventional methods peeling off.

However, since the manufacturing method of the coating layer according to the principles of the invention described above forms a multi-layered coating layer, a coating layer having increased hardness and increased thickness may be formed. Also, as the heterogeneous photoinitiator is included in the first coating layer and the wavelengths of the light irradiated when curing the first coating layer and the second coating layer are different, the adhesion of the first coating layer and the second coating layer is improved by the remaining photoinitiator. Accordingly, the method of manufacturing the coating layer according to the inventive concepts having increased hardness may be provided while also solving the peeling problem associated with multiple coating layers.

Further, to prevent the peeling in a conventional manufacturing method of the multi-layered coating layer, a separate process of performing a plasma treatment and introducing a primer between the multi-layered coating layer has been required. However, the method of manufacturing the coating layer according to the principles of the invention described herein may reduce or prevent peeling by use of the photocuring process that forms the coating layer without any separate additional processes, such as performing a plasma treatment and introducing a primer between the multi-layered coating layer. Accordingly, the manufacturing process may be simplified by use of the principles of the invention described herein.

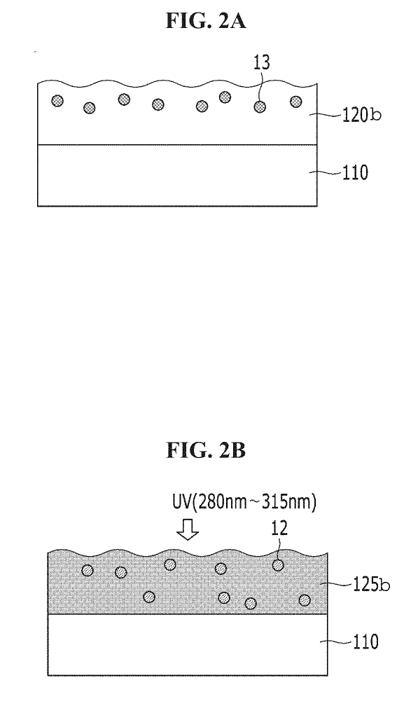

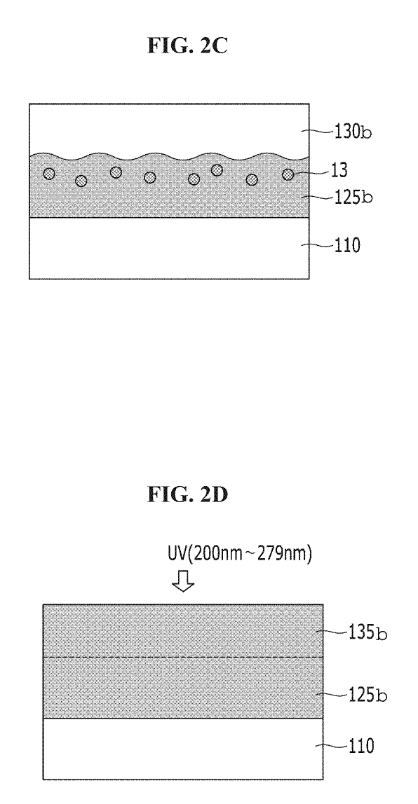

Referring to the exemplary embodiment of FIG. 2A, the first coating composition 120b including a hydrophilic leveling agent 13 is coated on the substrate 110.

The substrate 110 may include a plastic. In detail, the substrate 110 may include at least one material selected from the group including polycarbonate, poly(methylmethacrylate), and polyethylene phthalate.

The first coating composition 120b may include a hard coating material and the hydrophilic leveling agent 13. The first coating composition 120b may further include an inorganic nanoparticle as previously described. In detail, the first coating composition 120b includes the solvent, the oligomer, the monomer, the hydrophilic leveling agent 13, and the inorganic nanoparticle. The total weight of the oligomer, the monomer, the hydrophilic leveling agent 13, and the inorganic nanoparticle of the first coating composition 120 may be less than about 70 wt %. The inorganic nanoparticle may be less than about 5 wt %.

The description of the solvent, the oligomer, the monomer, and the inorganic nanoparticle is the same as above. The detailed description of the same constituent elements is omitted to avoid redundancy. The first coating composition 120b may include the hydrophilic leveling agent 13 with a content of less than about 1 wt %.

The hydrophilic leveling agent 13 may be one of compounds represented by Chemical Formula 1 and Chemical Formula 2.

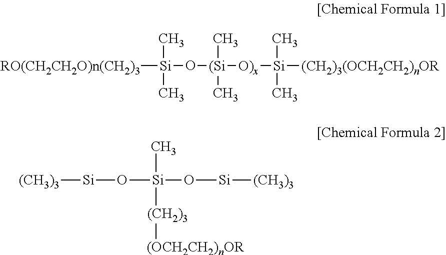

Herein, n and x are independently selected in the range of 1 to 20, and R is hydrogen.

In general, a leveling agent is a material that flattens the surface of the composition for the coating. However, when the hydrophilic leveling agent is included in the coating composition, the composition has viscosity such that protrusions and depressions are formed on the surface of the coating layer. This is because the hydrophilic leveling agent is driven in one direction while changing the surface energy of the coating composition.

Accordingly, as shown in FIG. 2A, the first coating composition 120b having the non-uniform surface is formed with the leveling agent 13 having risen towards that surface. Although not shown, the first coating composition 120b may also include a photoinitiator. A photoinitiator of a type may be included, as shown in FIGS. 1A-1D, or photoinitiators of two or more types may be included. The detailed description for the same constituent elements is omitted to avoid redundancy. But, it should be understood that the features and embodiments of FIGS. 1A-1D and FIGS. 2A-2D may be combined in whole or in part.

Next, referring to FIG. 2B, ultraviolet rays are irradiated to the first coating composition 120 to form the first coating layer 125b. In the irradiation process of ultraviolet rays, the protrusions and depressions and the viscosity of the surface of the first coating layer 125b may be maintained. This is because the hydrophilic leveling agent 13 does not react with the ultraviolet rays and thus remains in the first coating layer 125b.

Next, referring to FIG. 2C, the second coating composition 130b is coated on the first coating layer 125b. The second coating composition 130b may have the same composition as the first coating composition 120b except that the hydrophilic leveling agent 13 is not included. However, the composition of the second coating composition 130b also may be different from the composition of the first coating composition 120b.

The protrusions and depressions formed at the surface of the first coating layer 125b combine the second coating composition 130b and the first coating layer 125b to each other well by the anchor effect as described above. Also, the surface of the first coating layer 125b is in a sticky state due the hydrophilic leveling agent 13 such that the second coating composition 130b may be evenly adhered to the first coating layer 125b.

Next, referring to FIG. 2D, ultraviolet rays are irradiated into the second coating composition 130b to form the second coating layer 135b. The second coating composition 130b is cured by the irradiation of ultraviolet rays to become the second coating layer 135b. Thus, the second coating layer 135b is combined well with the first coating layer 125 by the hydrophilic leveling agent, and the protrusions and depressions of the boundary surface disappear in the combination process.

In the above, the first coating composition and the second coating composition respectively include a single, homogenous photoinitiator and hydrophilic leveling agent. However, this coating method may use the heterogeneous photoinitiator and the hydrophilic leveling agent. When using the heterogeneous photoinitiator and the hydrophilic leveling agent, the type of the photoinitiator included in each coating composition and the wavelength of the light used for the curing of each coating layer is the same as described above in the exemplary embodiment of FIGS. 1A-ID. The detailed description for the same constituent elements is omitted to avoid redundancy.

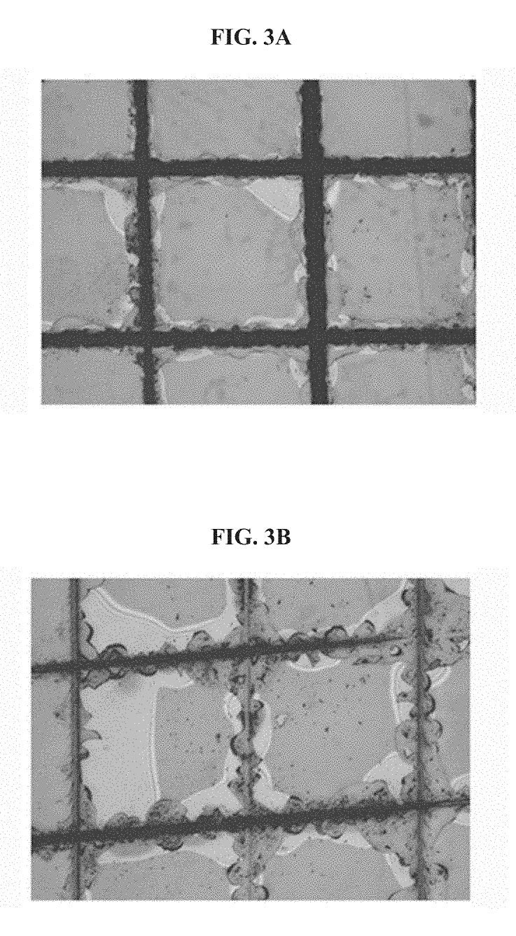

Next, the effect of a coating method according to the principles of the invention will be described with reference to FIGS. 3A and 3B, which depict the results of an adhesion test for experimental coating layers manufactured according to the principles of the invention and a comparative example, respectively.

FIG. 3A is an image of an adhesion test for the multi-layered coating structure performed by respectively curing the first coating composition including a heterogeneous photoinitiator and the second coating composition including a single, homogenous photoinitiator. FIG. 3B is an image of an adhesion test for the coating formed by respectively curing the first coating composition and the second coating composition where both of the first coating composition and the second coating composition include the same type of homogenous photoinitiator.

The adhesion test was performed by adhering and removing a tape to and from an upper surface of the coating layer after positioning the coating layer and then evaluating the degree to which the coating layer has peeled off. The image appears brighter when the coating layer is peeled off. As a result, as shown in FIG. 3A, the peeling only appears in a partial region, but the coating layer is well adhered. However, referring to FIG. 3B, the peeling appears in many parts of the coating layer and the adhesion is decreased as compared to FIG. 3A. That is, the adhesion test confirmed that interlayer adhesion of the coating layer formed according to the embodiment of FIGS. 1A-ID improved upon the adhesion achieved by an embodiment with a single, homogenous photoinitiator in each of multiple coating layers.

As described above, where a coating method according to the principles of the invention uses a first coating composition including a heterogeneous photoinitiator and cures each photoinitiator in different steps through different wavelengths, the interlayer adherence is improved in a multi-layered coating layer as compared to an equivalent that only uses a single, homogeneous photoinitiator in each of the multi-layered coatings. Also, as the multi-layered coating layer is formed, the coating layer has an increased thickness and an increased hardness.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A coating method comprising the steps of:
coating a first coating composition including a heterogeneous photoinitiator having a first photoinitiator and a second photoinitiator on a substrate;
irradiating ultraviolet rays having a first wavelength into the first coating composition to form a first coating layer and cure the first photoinitiator;
coating a second coating composition on the first coating layer; and
irradiating ultraviolet rays having a second wavelength different than the first wavelength into the second coating composition to form a second coating layer.

2. The coating method of claim 1, wherein
the first wavelength has a range of about 280 nm to about 315 nm.

3. The coating method of claim 1, wherein
the second wavelength has a range of about 200 nm to about 279 nm.

4. The coating method of claim 1, wherein,
in the step of forming the first coating layer,
the second photoinitiator does not react.

5. The coating method of claim 1, wherein
after the step of forming the first coating layer,
protrusions and depressions are formed at a surface of the first coating layer.

6. The coating method of claim 1, wherein
after the step of forming the first coating layer,
a surface of the first coating layer has a viscosity.

7. The coating method of claim 1, wherein the step of forming the second coating layer comprises curing the second photoinitiator included in the first coating layer.

8. The coating method of claim 1, wherein
the second coating composition includes the second photoinitiator.

9. The coating method of claim 1, wherein
the first photoinitiator comprises methyl-4′-(methylthio)-2-morpholinopropiophenone.

10. The coating method of claim 1, wherein
the second photoinitiator is one or more material selected from the group consisting of hydrocyclohexyl phenyl ketone, 2-hydroxy-2-methylpropiophenone, benzoin ethyl ether, benzoin methyl ether, and benzoin isobutyl ether.

11. The coating method of claim 1, wherein
the first coating composition comprises an oligomer, a monomer, and an inorganic nanoparticle.

12. The coating method of claim 11, wherein
the total weight of the oligomer, the monomer, the photoinitiator, and the inorganic nanoparticle included in the first coating composition is less than about 70 wt % of the first coating composition.

13. The coating method of claim 1, wherein
the substrate comprises one or more material selected from a group including polycarbonate, poly(methylmethacrylate), and polyethylene phthalate.

14. The coating method of claim 1, wherein
the step of forming the first coating layer comprises forming a height of the first coating layer in the range of about 5 μm to about 15 μm, and
the step of forming the second coating layer comprises forming a height of the second coating layer in the range of about 5 μm to about 15 μm.

15. A coating method comprising the steps of:
coating a first coating composition including a hydrophilic leveling agent onto a substrate;
irradiating ultraviolet rays into the first coating composition to form a first coating layer;
coating a second coating composition onto the first coating layer; and
irradiating ultraviolet rays into the second coating composition to form a second coating layer.

16. The coating method of claim 15, wherein
the hydrophilic leveling agent is one or more compounds selected from a compound represented by Chemical Formula 1 and a compound represented by Chemical Formula 2, and the hydrophilic leveling agent is included in the first coating composition at less than about 1 wt %: 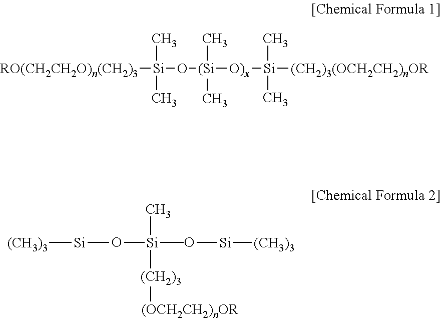
wherein n and x are independently 1 to 20, and R is hydrogen.

17. The coating method of claim 15, wherein,
after the step of forming the first coating layer,
protrusions and depressions are formed at a surface of the first coating layer.

18. The coating method of claim 15, wherein,
after the step of forming the first coating layer,
a surface of the first coating layer has a viscosity.

19. The coating method of claim 15, wherein
the step of forming the first coating layer comprises forming a height of the first coating layer in the range of about 5 μm to about 15 μm, and
the step of forming the second coating layer comprises forming a height of the second coating layer in the range of about 5 μm to about 15 μm.

20. The coating method of claim 15, wherein:
the heterogeneous photoinitiator comprises a first photoinitiator cured in the first wavelength range and a second photoinitiator cured in the second wavelength range;
the second coating composition includes the second photoinitiator cured in the second wavelength range;
the first wavelength is in the range of about 280 nm to about 315 nm; and
the second wavelength is in the range of about 200 nm to about 279 nm.
